(19) United States
(12) Patent Application Publication
(10) Pub. No.: US 2026/0089553 A1
(43) Pub. Date: Mar. 26, 2026

(54) UNIFIED BUFFER AND DELAY STATUS REPORTING

(71) Applicant: QUALCOMM Incorporated, San Diego, CA (US)

(72) Inventor: Linhai HE, San Diego, CA (US)

(21) Appl. No.: 19/317,125

(22) Filed: Sep. 2, 2025

Related U.S. Application Data
(60) Provisional application No. 63/699,024, filed on Sep. 25, 2024.

(51) Int. Cl. H04W 28/02

(52) U.S. Cl. CPC H04W 28/0278; H04W 24/10

(57) ABSTRACT

Methods, systems, and devices for wireless communications are described in which a user equipment (UE) may be configured to transmit a buffer status report (BSR) that provides a unified buffer and delay status. The UE may trigger a BSR based on arrival of new data at a UE buffer for a logical channel if an associated time threshold is met, where one or multiple time thresholds may be configured for each logical channel. A first BSR may be transmitted upon data arrival at the UE buffer, and a second BSR may be transmitted if at least some of the data remains the uplink buffer at the UE when the second time threshold is met. The network entity may take action to schedule uplink resources for the UE based on the received BSR(s).

### CROSS REFERENCE

The present Application for Patent claims the benefit of U.S. Provisional Ser. No. 63/699,024 by HE, entitled “UNIFIED BUFFER AND DELAY STATUS REPORTING,” filed Sep. 25, 2024, assigned to the assignee hereof, and which is expressly incorporated by reference herein.

### FIELD OF TECHNOLOGY

The following relates to wireless communications, including unified buffer and delay status reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data, obtaining, at a first data arrival time, first data to be transmitted in one or more uplink transmissions, and initiating a unified delay and buffer status report to notify a network entity of a quantity of data that is buffered at the UE for uplink transmission based on one or more of the first time threshold or the second time threshold and an elapsed time from the first data arrival time.

A UE for wireless communications is described. The UE may include one or more memories storing processor executable code, and one or more processors coupled with the one or more memories. The one or more processors may individually or collectively be operable to execute the code to cause the UE to receive a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data, obtain, at a first data arrival time, first data to be transmitted in one or more uplink transmissions, and initiate a unified delay and buffer status report to notify a network entity of a quantity of data that is buffered at the UE for uplink transmission based on one or more of the first time threshold or the second time threshold and an elapsed time from the first data arrival time.

Another UE for wireless communications is described. The UE may include means for receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data, means for obtaining, at a first data arrival time, first data to be transmitted in one or more uplink transmissions, and means for initiating a unified delay and buffer status report to notify a network entity of a quantity of data that is buffered at the UE for uplink transmission based on one or more of the first time threshold or the second time threshold and an elapsed time from the first data arrival time.

A non-transitory computer-readable medium storing code for wireless communications is described. The code may include instructions executable by one or more processors to receive a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data, obtain, at a first data arrival time, first data to be transmitted in one or more uplink transmissions, and initiate a unified delay and buffer status report to notify a network entity of a quantity of data that is buffered at the UE for uplink transmission based on one or more of the first time threshold or the second time threshold and an elapsed time from the first data arrival time.

In some examples of the method, UEs, and non-transitory computer-readable medium described herein, the data is associated with a first logical channel of one or more logical channels configured at the UE, and separate buffer status report configurations may be provided for each logical channel of the one or more logical channels. In some examples of the method, UEs, and non-transitory computer-readable medium described herein, the unified delay and buffer status report indicates the quantity of data that is buffered at the UE for uplink transmission and a delay status associated with the data.

In some examples of the method, UEs, and non-transitory computer-readable medium described herein, receiving the buffer status report configuration may include operations, features, means, or instructions for receiving the first time threshold associated with the first duration between obtaining the data and transmission of the data and receiving the second time threshold associated with the second duration between obtaining the data and transmission of the data.

Some examples of the method, UEs, and non-transitory computer-readable medium described herein may further include operations, features, means, or instructions for determining that at least a first portion of the data that is buffered at the UE for uplink transmission has been in an uplink buffer at the UE for at least the first duration, initiating a first unified delay and buffer status report to notify the network entity that at least the first portion of the data has been in the uplink buffer at the UE for at least the first duration, determining, subsequent to initiating the first unified delay and buffer status report, that at least a second portion of the data that is buffered at the UE for uplink transmission has been in the uplink buffer at the UE for at least the second duration, and initiating a second unified delay and buffer status report to notify the network entity that at least the second portion of the data has been in the uplink buffer at the UE for at least the second duration.

In some examples of the method, UEs, and non-transitory computer-readable medium described herein, the first time threshold is configured to trigger initiation of the unified delay and buffer status report when new data is obtained for a first logical channel associated with the buffer status report configuration. In some examples of the method, UEs, and non-transitory computer-readable medium described herein, the second time threshold is configured to trigger a second unified delay and buffer status report when at least a portion of the data associated with the first logical channel is present for a duration of time indicated by the second time threshold.

In some examples of the method, UEs, and non-transitory computer-readable medium described herein, one or more of the first time threshold or the second time threshold is associated with a prohibit timer that is initiated upon transmission of an associated unified delay and buffer status report and a subsequent unified delay and buffer status report for an associated time threshold is not transmitted prior to an expiration of the prohibit timer.

In some examples of the method, UEs, and non-transitory computer-readable medium described herein, initiating the unified delay and buffer status report may include operations, features, means, or instructions for determining that at least a portion of the data that is buffered at the UE for uplink transmission has been in an uplink buffer of a logical channel at the UE for at least the first duration, determining that a pending unified delay and buffer status report associated with the logical channel is not present, determining that a prohibit timer associated with the first duration is not running, and generating the unified delay and buffer status report for transmission to the network entity. Some examples of the method, UEs, and non-transitory computer-readable medium described herein may further include operations, features, means, or instructions for canceling the unified delay and buffer status report if a different unified delay and buffer status report has indicated the quantity of data that is buffered at the UE, if the data that is buffered at the UE has been transmitted, or if the data that is buffered at the UE has been discarded. In some examples of the method, UEs, and non-transitory computer-readable medium described herein, the quantity of data that is buffered at the UE for uplink transmission includes one or more service data units (SDUs) that have been buffered for at least the first duration associated with the first time threshold.

In some examples of the method, UEs, and non-transitory computer-readable medium described herein, initiating the unified delay and buffer status report may include operations, features, means, or instructions for determining that a quantity of unified delay and buffer status reports that have been triggered in a first time period do not exceed a threshold quantity of unified delay and buffer status reports.

In some examples of the method, UEs, and non-transitory computer-readable medium described herein, the buffer status report configuration indicates two or more reporting thresholds associated with different time parameters for data that is buffered at the UE to be reported in the unified delay and buffer status report and a quantity of reporting thresholds are independent of a quantity of time thresholds.

In some examples of the method, UEs, and non-transitory computer-readable medium described herein, the quantity of data associated with each reporting threshold that is buffered at the UE is indicated in the unified delay and buffer status report, including a first quantity of data having a remaining time in an associated packet delay budget that is less than a first reporting threshold and the unified delay and buffer status report further indicates a shortest remaining time among the first quantity of data that is less than the first reporting threshold. In some examples of the method, UEs, and non-transitory computer-readable medium described herein, the first quantity of data and the shortest remaining time is provided for each of the two or more reporting thresholds that are not higher than an associated time threshold for triggering the unified delay and buffer status report.

A method for wireless communications by a network entity is described. The method may include transmitting, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data, receiving, from the UE, a unified delay and buffer status report that indicates a quantity of data that is buffered at the UE for uplink transmission and that is to be transmitted within the first time threshold or the second time threshold, and scheduling uplink resources for uplink transmissions of the UE based on the unified delay and buffer status report.

A network entity for wireless communications is described. The network entity may include one or more memories storing processor executable code, and one or more processors coupled with the one or more memories. The one or more processors may individually or collectively be operable to execute the code to cause the network entity to transmit, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data, receive, from the UE, a unified delay and buffer status report that indicates a quantity of data that is buffered at the UE for uplink transmission and that is to be transmitted within the first time threshold or the second time threshold, and scheduling uplink resources for uplink transmissions of the UE base at least in part on the unified delay and buffer status report.

Another network entity for wireless communications is described. The network entity may include means for transmitting, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data, means for receiving, from the UE, a unified delay and buffer status report that indicates a quantity of data that is buffered at the UE for uplink transmission and that is to be transmitted within the first time threshold or the second time threshold, and means for scheduling uplink resources for uplink transmissions of the UE based on the unified delay and buffer status report.

A non-transitory computer-readable medium storing code for wireless communications is described. The code may include instructions executable by one or more processors to transmit, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data, receive, from the UE, a unified delay and buffer status report that indicates a quantity of data that is buffered at the UE for uplink transmission and that is to be transmitted within the first time threshold or the second time threshold, and scheduling uplink resources for uplink transmissions of the UE base at least in part on the unified delay and buffer status report.

In some examples of the method, network entities, and non-transitory computer-readable medium described herein, the buffer status report configuration is associated with a first logical channel of one or more logical channels configured at the UE, and separate buffer status report configurations is provided for each logical channel of the one or more logical channels. In some examples of the method, network entities, and non-transitory computer-readable medium described herein, the unified delay and buffer status report indicates the quantity of data that is buffered at the UE for uplink transmission and a delay status associated with the data.

In some examples of the method, network entities, and non-transitory computer-readable medium described herein, transmitting the buffer status report configuration may include operations, features, means, or instructions for transmitting the first time threshold associated with the first duration between obtaining the data and transmission of the data and transmitting the second time threshold associated with the second duration between obtaining the data and transmission of the data.

In some examples of the method, network entities, and non-transitory computer-readable medium described herein, the unified delay, and buffer status report that indicates that at least a first portion of the data has been in an uplink buffer at the UE for at least the first duration, and where the method may include operations, features, means, or instructions for receiving a second unified delay and buffer status report that indicates that at least a second portion of the data has been in the uplink buffer at the UE for at least the second duration. In some examples of the method, network entities, and non-transitory computer-readable medium described herein, the first time threshold is configured to trigger initiation of the first unified delay and buffer status report when new data is obtained for a first logical channel associated with the buffer status report configuration. In some examples of the method, network entities, and non-transitory computer-readable medium described herein, the second time threshold is configured to trigger the second unified delay and buffer status report when at least a portion of the data associated with the first logical channel is present for a duration of time indicated by the second time threshold.

In some examples of the method, network entities, and non-transitory computer-readable medium described herein, one or more of the first time threshold or the second time threshold is associated with a prohibit timer that is initiated upon transmission of an associated unified delay and buffer status report and a subsequent unified delay and buffer status report for an associated time threshold is not transmitted prior to an expiration of the prohibit timer. In some examples of the method, network entities, and non-transitory computer-readable medium described herein, the buffer status report configuration further indicates a prohibit timer duration associated with the first time threshold and a second unified delay and buffer status report associated with the first time threshold is not to be transmitted within the prohibit timer duration from the unified delay and buffer status report.

In some examples of the method, network entities, and non-transitory computer-readable medium described herein, the buffer status report configuration further indicates to cancel the unified delay and buffer status report if a different unified delay and buffer status report has indicated the quantity of data that is buffered at the UE, if the data that is buffered at the UE has been transmitted, or if the data that is buffered at the UE has been discarded. In some examples of the method, network entities, and non-transitory computer-readable medium described herein, the quantity of data that is buffered at the UE for uplink transmission includes one or more service data units (SDUs) that have been buffered for at least the first duration associated with the first time threshold.

In some examples of the method, network entities, and non-transitory computer-readable medium described herein, the buffer status report configuration further indicates a threshold quantity of unified delay and buffer status reports that can be triggered during a first time period. In some examples of the method, network entities, and non-transitory computer-readable medium described herein, the buffer status report configuration indicates two or more reporting thresholds associated with different time parameters for data that is buffered at the UE to be reported in the unified delay and buffer status report and a quantity of reporting thresholds is independent of a quantity of time thresholds.

In some examples of the method, network entities, and non-transitory computer-readable medium described herein, the quantity of data associated with each reporting threshold that is buffered at the UE is indicated in the unified delay and buffer status report, including a first quantity of data having a remaining time in an associated packet delay budget that is less than a first reporting threshold and the unified delay and buffer status report further indicates a shortest remaining time among the first quantity of data that is less than the first reporting threshold. In some examples of the method, network entities, and non-transitory computer-readable medium described herein, the first quantity of data and the shortest remaining time is provided for each of the two or more reporting thresholds that is not higher than an associated time threshold for triggering the unified delay and buffer status report.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports unified buffer and delay status reporting in accordance with one or more aspects of the present disclosure.

FIG. 2 shows an example of a wireless communications system that supports unified buffer and delay status reporting in accordance with one or more aspects of the present disclosure.

FIG. 3 shows example timing diagrams that support unified buffer and delay status reporting in accordance with one or more aspects of the present disclosure.

FIG. 4 shows example timing diagrams that support unified buffer and delay status reporting in accordance with one or more aspects of the present disclosure.

FIGS. 5 and 6 show block diagrams of devices that support unified buffer and delay status reporting in accordance with one or more aspects of the present disclosure.

FIG. 7 shows a block diagram of a communications manager that supports unified buffer and delay status reporting in accordance with one or more aspects of the present disclosure.

FIG. 8 shows a diagram of a system including a device that supports unified buffer and delay status reporting in accordance with one or more aspects of the present disclosure.

FIGS. 9 and 10 show block diagrams of devices that support unified buffer and delay status reporting in accordance with one or more aspects of the present disclosure.

FIG. 11 shows a block diagram of a communications manager that supports unified buffer and delay status reporting in accordance with one or more aspects of the present disclosure.

FIG. 12 shows a diagram of a system including a device that supports unified buffer and delay status reporting in accordance with one or more aspects of the present disclosure.

FIGS. 13 through 16 show flowcharts illustrating methods that support unified buffer and delay status reporting in accordance with one or more aspects of the present disclosure.

### DETAILED DESCRIPTION

In some wireless communications systems, a user equipment (UE) may report an amount of data that is present at the UE that is to be transmitted to a network entity. For example, a UE may receive application data from an application layer that is to be transmitted in one or more uplink transmissions to the network entity. The application data may be stored in an uplink buffer at the UE while awaiting transmission, and the UE may transmit a buffer status report (BSR) to the network entity that indicates a quantity of data that is in the uplink buffer. The network entity may use this report to schedule uplink resources that the UE may use to transmit the uplink data. In some systems, a BSR may be triggered at the UE based on arrival of new data at the UE (e.g., when the UE obtains new data in its uplink buffer from an application layer). In some examples, upon arrival of new data, the UE will trigger a BSR unless a prohibit timer is running, where the prohibit timer may be configured to prevent transmission of a BSR relatively frequently and, at the expiration of the prohibit timer, the UE may transmit a BSR that indicates updated values for the uplink buffer that account for new data arrival(s) and uplink data transmissions.

Further, some wireless communication systems provide that a UE may provide a delay status report (DSR) that indicates that uplink data has been in the uplink buffer for some amount of time that may be configured at the UE. For example, data of some services or applications may have a packet delay budget (PDB) that indicates an amount of time the data may reside in the uplink buffer before becoming stale and no longer useful (e.g., voice packets for a voice call may have a PDB associated with a target delay value for a quality of service (QoS) of the voice call, and packets that remain in the uplink buffer for longer than the PDB may be discarded). The DSR may allow the network entity to consider the amount of data and the amount of time the data has been in the uplink buffer when scheduling resources to multiple UEs. In cases where a UE is transmitting delay sensitive data, it may be advantageous to provide the network entity with information related to both a buffer status and a delay status for uplink data that is buffered at the UE.

In accordance with various aspects discussed herein, a wireless device, such as a UE, may transmit a unified buffer and delay status report. In some aspects, a UE may trigger an enhanced or unified BSR (which may be referred to as an eBSR, a unified delay and buffer status report (UDBSR), or just BSR, herein) based on arrival of new data for a logical channel if an associated time threshold is met, where one or multiple time thresholds may be configured for each logical channel. In some aspects, a first time threshold may be set to the PDB for a first reporting threshold, which may provide a UDBSR being transmitted upon receipt of data into the uplink buffer at the UE (e.g., when a prohibit timer is not currently running), and thus providing similar behavior as a legacy BSR trigger. In some aspects, a second time threshold may be set to be shorter than the PDB, and if data is remaining in the uplink buffer at the UE until the second time threshold is met, a second UDBSR may be triggered to report the amount of data that has been in the buffer for an amount of time that corresponds to the second time threshold. The network entity may take action to schedule uplink resources for the UE based on the received UDBSR(s). Such techniques may allow for a unified BSR report that provides an indication of both a quantity of data at an uplink buffer at a UE, and an indication of data in the buffer that is approaching a time threshold that indicates the data is stale or no longer useful. Such a unified report may allow for efficient reporting of buffer status and delay information to a network entity, with reduced overhead relative to separate BSR and DSR reports. Thus, network efficiency may be enhanced, UE power consumption may be reduced, and user experience may be improved.

Aspects of the disclosure are initially described in the context of wireless communications systems. Aspects of the disclosure are further illustrated by and described with reference to timing diagrams, apparatus diagrams, system diagrams, and flowcharts that relate to unified buffer and delay status reporting.

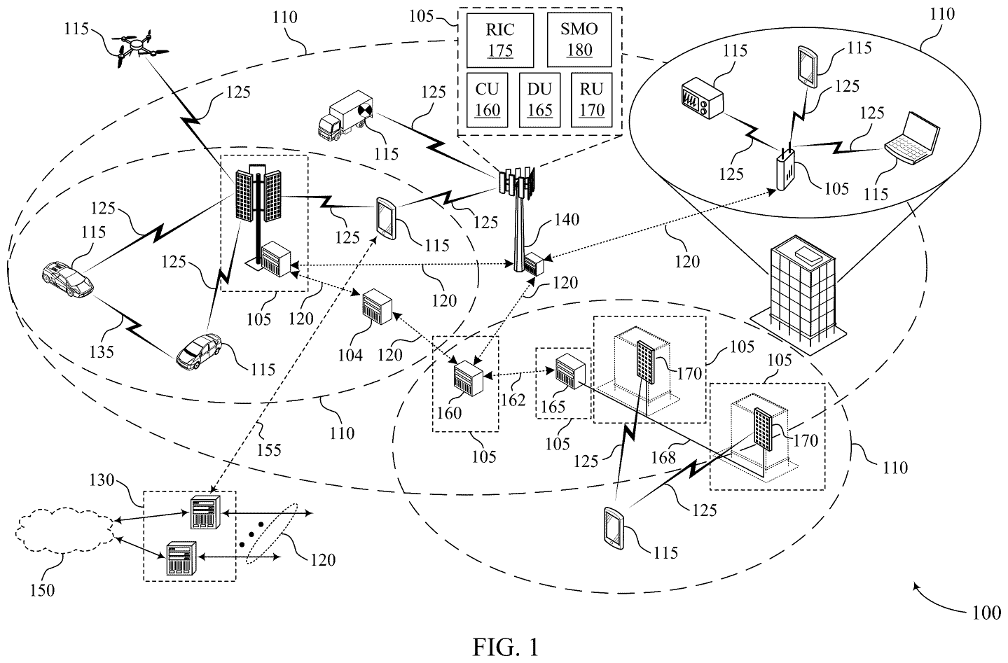

FIG. 1 shows an example of a wireless communications system 100 that supports unified buffer and delay status reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support unified buffer and delay status reporting as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods.

The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In accordance with various aspects discussed herein, a UE 115, may transmit a unified buffer and delay status report to a network entity 105. In some aspects, the UE 115 may trigger a UDBSR with both buffer and delay information based on arrival of new data for a logical channel if an associated time threshold is met, where one or multiple time thresholds may be configured for each logical channel. In some aspects, a first time threshold may be set to the PDB for a first reporting threshold, and a second time threshold may be set to be shorter than the PDB. Thus, a first UDBSR may be transmitted upon data arrival at the UE buffer, and a second UDBSR may be transmitted if at least some of the data remains the uplink buffer at the UE when the second time threshold is met. The network entity 105 may take action to schedule uplink resources for the UE 115 based on the received UDBSR(s).

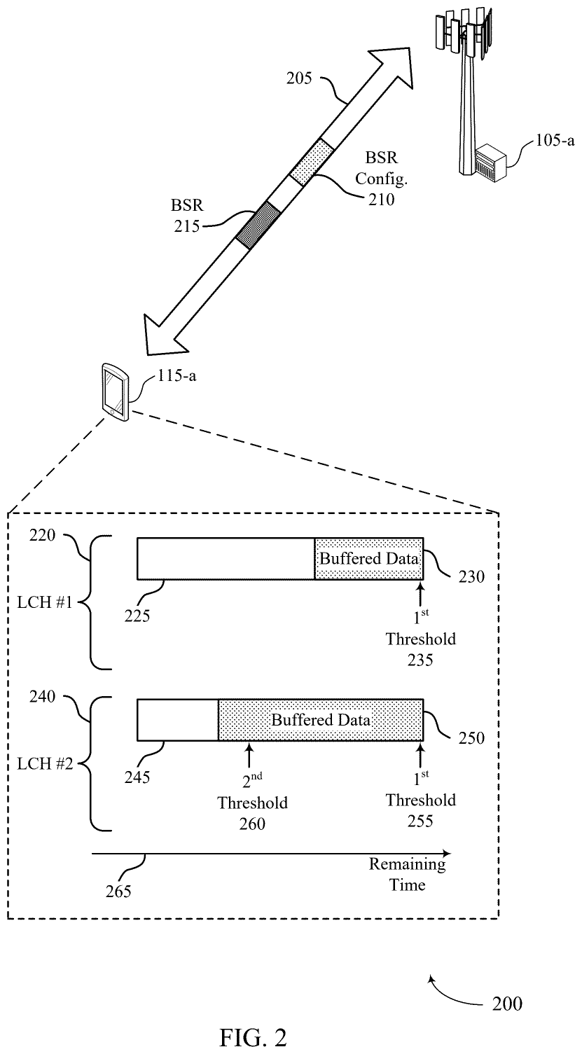

FIG. 2 shows an example of a wireless communications system 200 that supports unified buffer and delay status reporting in accordance with one or more aspects of the present disclosure. The wireless communications system 200 may implement or be implemented by aspects of the wireless communications system 100 as described herein with reference to FIG. 1. For example, the wireless communications system 200 may include a UE 115-a and a network entity 105-a, which may be an example of UEs 115 and network entities 105 as described herein with reference to FIG. 1. The wireless communications system 200 may support 3G, 4G, 5G, 6G, or radio access technologies beyond 6G.

The UE 115-a and the network entity 105-a may perform wireless communication (e.g., one or more of receiving, obtaining, transmitting, or outputting one or more of control information, configuration information, or data) via a communication link 205, which may be examples of communications links 125 as described herein with reference to FIG. 1. In some cases, the network entity 105-a may provide a BSR configuration 210 to the UE 115-a, and the UE 115-a may transmit one or more BSRs 215 (e.g., an eBSR or UDBSR) in accordance with the BSR configuration 210. Further, in some cases, the UE 115-a may transmit a capability indication to the network entity 105-a that indicates that the UE 115-a is capable of providing unified BSRs, or eBSRs or UDBSRs, that provide a unified report of a buffer and delay status at the UE 115-a. The network entity 105-a may provide the BSR configuration 210 responsive to the UE 115-a capability that includes multiple threshold values per logical channel that may trigger the UE 115-a to transmit one or more BSRs 215.

As discussed herein, the UE 115-a may transmit a unified buffer and delay status report as one or more BSRs 215. In some aspects, the UE 115-a may trigger a BSR 215 (e.g., a first UDBSR) based on arrival of new data for a first logical channel 220 if an associated first time threshold 235 is met. For example, the first logical channel 220 may have an uplink buffer 225 with a first quantity of buffered data 230, and the first time threshold 235 may be configured such that a BSR 215 is triggered upon arrival of the buffered data 230 in the uplink buffer 225 (e.g., the first time threshold 235 may be set to be equal to a packet delay budget (PDB) of the associated data). In some cases, data for a logical channel, such as buffered data 230 of the first logical channel 220, may be delay-insensitive data (e.g., enhanced mobile broadband (eMBB) data that does not have a latency target, or data that is in a best efforts queue at the UE 115-a). Thus, in the example of the first logical channel 220, a BSR 215 may be transmitted upon receipt of data into the uplink buffer 225 at the UE 115-a (e.g., when a prohibit timer is not currently running), thus providing similar behavior as a legacy BSR trigger.

In other examples, two or more thresholds may be configured, such as for second logical channel 240 that has an associated first time threshold 255 and a second time threshold 260. In some aspects, a second time threshold 260 may be set to be shorter than the PDB, and if buffered data 250 is remaining in the uplink buffer 245 at the UE 115-a until the second time threshold 260 is met, a second BSR 215 may be triggered to report the amount of data that has been in the uplink buffer 245 for an amount of time that corresponds to the second time threshold 260. For example, the second time threshold 260 may be set to be a predetermined amount of time prior to a remaining time 265 of the PDB of the buffered data 250. The network entity 105-a may take action to schedule uplink resources for the UE 115-a based on the received BSR(s) 215 (e.g., received UDBSRs). In some examples, each triggering threshold (e.g., first time threshold 255 and second time threshold 260) may be associated with an optional prohibit timer, to avoid over reporting.

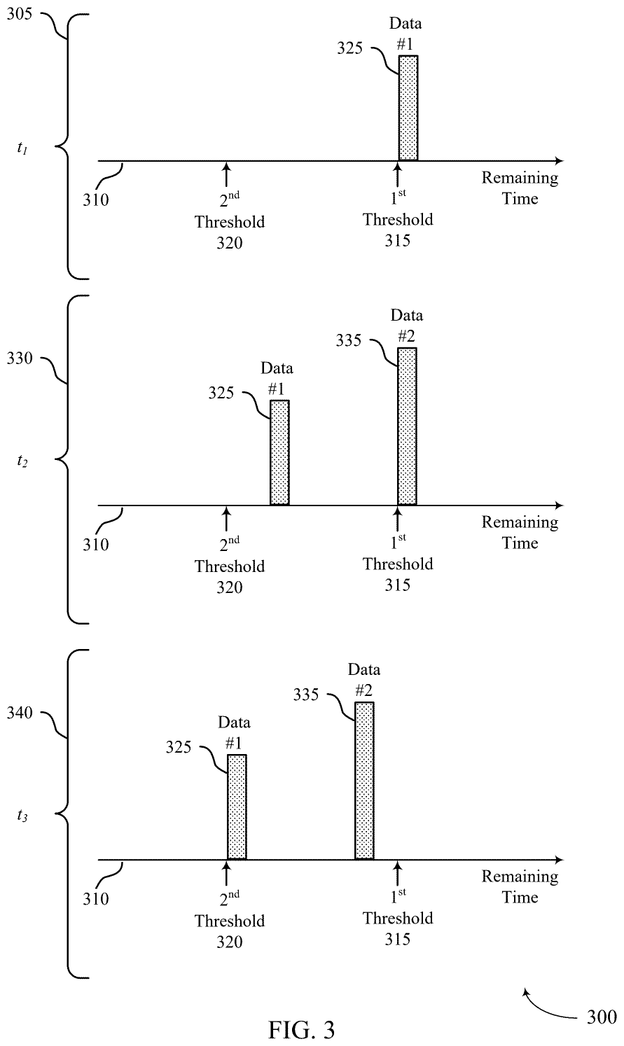

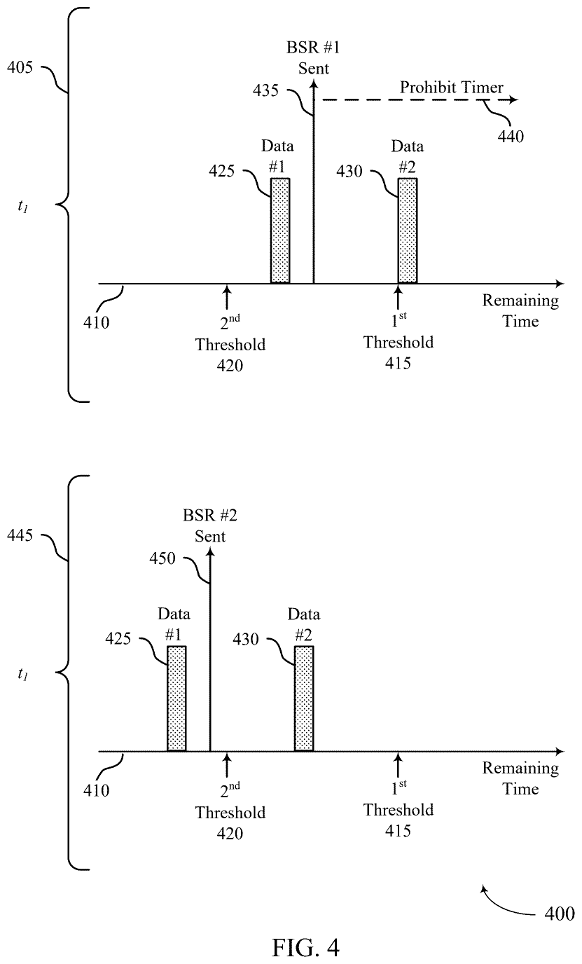

For example: for flows such as associated with the first logical channel 220 without a delay requirement, the network entity 105-a may configure a soft PDB (e.g. 50 msec) and only an associated first time threshold 235 as a triggering threshold, which equals the PDB. As a result, a BSR 215 (e.g., a UDBSR) is triggered only when data arrives in the first logical channel 220. For other flows, such as for the second logical channel 240, the network entity 105-a may configure multiple triggering thresholds, such as associated first time threshold 255 and second time threshold 260, which may trigger a first BSR 215 (e.g., a first UDBSR) when new data arrives (e.g., uplink data is obtained from an application layer for uplink transmission) for the second logical channel, and a second BSR 215 (e.g., a second UDBSR) may be triggered when a shortest remaining time of the buffered data 250 in the second logical channel 240 becomes too small. FIGS. 3 and 4 provide further examples of triggering thresholds and BSRs in accordance with various aspects.

FIG. 3 show example of a timing diagrams 300 that supports unified buffer and delay status reporting in accordance with one or more aspects of the present disclosure. The timing diagrams 300 may implement or be implemented by one or more aspects of the wireless communications system 100 and the wireless communications system 200 described with reference to FIGS. 1 and 2, respectively. For example, the timing diagram 300 may be implemented by a network entity 105 and a UE 115 as described with reference to FIGS. 1 and 2 to support reduced overhead and enhanced network efficiency through implementation of a unified buffer and delay status report.

For example, the timing diagram 300 illustrates a first time instance 305 (t₁) which may correspond to a time at which first data 325 (data #1) arrives at an uplink buffer at a UE (e.g., an arrival time of uplink data from an application layer at the UE) for a logical channel. The first data 325 may have a remaining time 310 that corresponds to an associated PDB minus the time that the data has spent in the uplink buffer. In this example, a first time threshold 315 may be configured that corresponds to an amount of time of the PDB, and a second time threshold 320 may be configured that corresponds to an amount of time that is shorter than the PDB, such that a UDBSR may be triggered prior to an expiration of the PDB to notify a network entity that data at the UE is approaching its PDB, which the network may then take into consideration when allocating resources for uplink transmissions to UEs.

In accordance with various aspects, a UDBSR may be triggered at the UE when the shortest remaining time of the first data 325 (e.g., data in logical channel) drops below one of the triggering thresholds (e.g., below the first time threshold 315 or the second time threshold 320). In some aspects, the trigger for the UDBSR may also be based on the condition that there is no pending UDBSR associated with the same triggering threshold for this logical channel, and a prohibit timer (if configured) associated with the triggering threshold is not running. Continuing with the example of FIG. 3, at a second time instance 330 (t₂) second data 335 (data #2) may be received in the uplink buffer. The second data 335 may trigger a transmission of a UDBSR associated with the first time threshold 315. In some examples, the second data 335 may not trigger a transmission of the UDBSR due to an active prohibit timer (e.g., associated with the first data 325) that is running, or due to a pending UDBSR associated with the first data 325. Further, at a third time instance 340 (t₃), the first data 325 may be present in the uplink buffer for a duration of time that corresponds to the second time threshold 320, which may trigger a second UDBSR associated with the first data 325.

In some aspects, a pending UDBSR may be canceled such as, for example, when data associated with the BSR has been reported in another UDBSR (e.g., reported in a MAC control element (CE) that reports the data as being in an uplink buffer at the UE), when the data associated with the UDBSR is included in an uplink transmission (e.g., transmitted or scheduled for transmission in a physical uplink shared channel (PUSCH) transmission from the UE), or when the associated data is discarded by higher-layers (e.g., due to the data remaining in the uplink buffer beyond an associated PDB). In some cases, a service data unit (SDU) may be associated with a pending UDBSR if its remaining time is below the threshold that triggered the UDBSR, and may be included when providing the amount of data in the uplink buffer at the UE. In some aspects, as an alternative to a prohibit timer, a network entity may can configure the UE with at most N UDBSRs that may be triggered within T msec, and when to trigger a UDBSR may be up to UE implementation. In some further aspects, a prohibit timer may be replaced by an artificial intelligence (AI) or machine learning (ML) procedure that triggers UDBSR transmissions based on a quantity of uplink data and arrival time of the uplink data, in accordance with an AI/ML model.

FIG. 4 shows an example of a timing diagram 400 that supports unified buffer and delay status reporting in accordance with one or more aspects of the present disclosure. The timing diagrams 300 may implement or be implemented by one or more aspects of the wireless communications system 100 and the wireless communications system 200 described with reference to FIGS. 1 and 2, respectively. For example, the timing diagram 400 may be implemented by a network entity 105 and a UE 115 as described with reference to FIGS. 1 and 2 to support reduced overhead and enhanced network efficiency through implementation of a unified buffer and delay status report.

For example, the timing diagram 400 illustrates a first time instance 405 (t₁) which may correspond to a time at which second data 430 (data #2) arrives at an uplink buffer at a UE (e.g., an arrival time of uplink data from an application layer at the UE) for a logical channel. The second data 430 may arrive after first data 425 (data #1), and subsequent to a transmission of a first UDBSR 435 and while an associated prohibit timer 440 is running. In this example, the associated logical channel may have a first time threshold 415 and a second time threshold 420 configured for triggering a UDBSR based on a remaining time 410 that corresponds to an associated PDB minus the time that the data has spent in the uplink buffer. In this example, similarly as discussed above, a first time threshold 415 may be configured that corresponds to an amount of time of the PDB, and a second time threshold 420 may be configured that corresponds to an amount of time that is shorter than the PDB, such that a UDBSR may be triggered prior to an expiration of the PDB to notify a network entity that data at the UE is approaching its PDB, which the network may then take into consideration when allocating resources for uplink transmissions to UEs. In the example of FIG. 4, at a second time instance 445 (t₂), the first data 425 has remained in the uplink buffer beyond the second time threshold 420, and the UE may transmit a second UDBSR 450.

In some aspects, a network entity may configure multiple reporting thresholds, and there can be more reporting thresholds than triggering thresholds. For example, multiple reporting thresholds associated with different quantities of data may be configured, which may include more reporting thresholds than triggering thresholds. In some aspects, for each logical channel with at least one pending UDBSR, for each pending UDBSR of the logical channel and its associated triggering threshold, for each reporting threshold not higher than this triggering threshold, the UE may include the size of the buffered data whose remaining time is less than the associated reporting threshold, and a shortest remaining time among data that is less than the reporting threshold, if this information has is not implicit based on the configured reporting thresholds.

For example, in FIG. 4, if the first UDBSR 435 is to be sent, as there is a pending UDBSR associated with the first time threshold 415, the first data 425 is reported. Note that in this case, the second data 430 may not trigger a new UDBSR due to the prohibit timer 440 started by the first UDBSR 435. Further, when the second UDBSR 450 is sent, because only the second time threshold 420 has a pending UDBSR, only the first data 425 is reported as associated with the second time threshold 420. However, if the prohibit timer 440 had expired, or is not configured for the first time threshold 415, the second data 430 may trigger a UDBSR for the first time threshold 415, and then the second UDBSR 450 may contain information for both the first data 425 and the second data 430. As discussed, in some cases different reporting thresholds may be configured, and the first UDBSR 435 and the second UDBSR 450 may further report data in accordance with the one or more reporting thresholds.

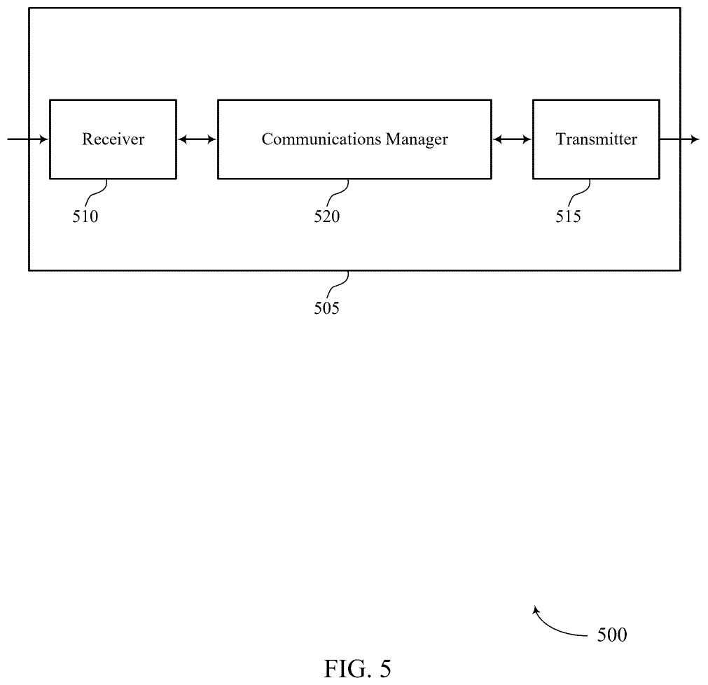

FIG. 5 shows a block diagram 500 of a device 505 that supports unified buffer and delay status reporting in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to unified buffer and delay status reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to unified buffer and delay status reporting). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of unified buffer and delay status reporting as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The communications manager 520 is capable of, configured to, or operable to support a means for obtaining, at a first data arrival time, first data to be transmitted in one or more uplink transmissions. The communications manager 520 is capable of, configured to, or operable to support a means for initiating a unified delay and buffer status report to notify a network entity of a quantity of data that is buffered at the UE for uplink transmission based on one or more of the first time threshold or the second time threshold and an elapsed time from the first data arrival time.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for a unified BSR report that provides an indication of both a quantity of data at an uplink buffer at a UE, and an indication of data in the buffer that is approaching a time threshold that indicates the data is stale or no longer useful. Such a unified report may allow for efficient reporting of buffer status and delay information to a network entity, reduced processing, reduced power consumption through transmission of fewer reports, and reduced overhead.

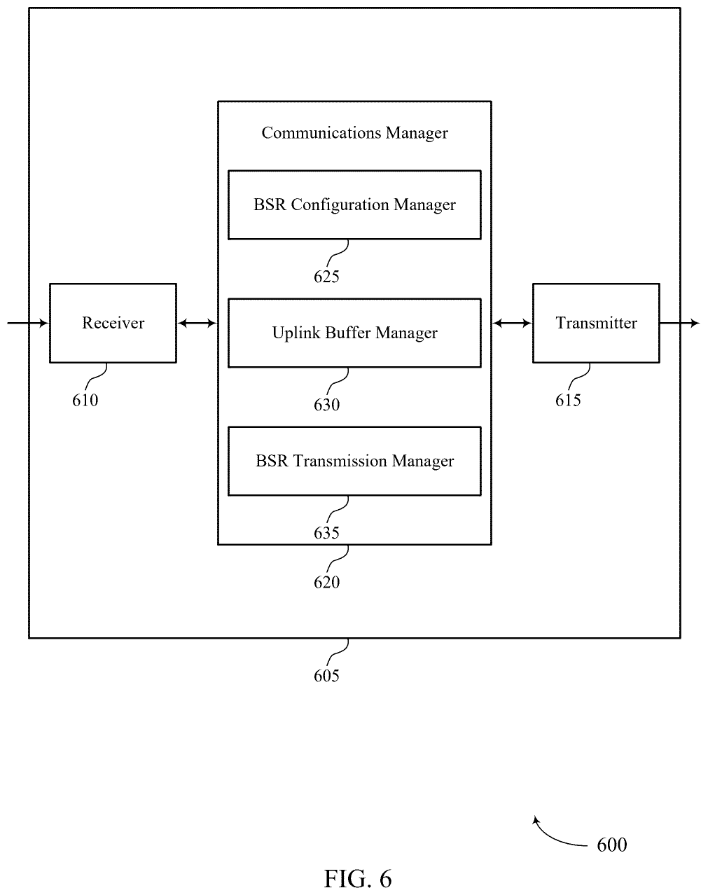

FIG. 6 shows a block diagram 600 of a device 605 that supports unified buffer and delay status reporting in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to unified buffer and delay status reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to unified buffer and delay status reporting). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of unified buffer and delay status reporting as described herein. For example, the communications manager 620 may include an BSR configuration manager 625, an uplink buffer manager 630, an BSR transmission manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The BSR configuration manager 625 is capable of, configured to, or operable to support a means for receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The uplink buffer manager 630 is capable of, configured to, or operable to support a means for obtaining, at a first data arrival time, first data to be transmitted in one or more uplink transmissions. The BSR transmission manager 635 is capable of, configured to, or operable to support a means for initiating a unified delay and buffer status report to notify a network entity of a quantity of data that is buffered at the UE for uplink transmission based on one or more of the first time threshold or the second time threshold and an elapsed time from the first data arrival time.

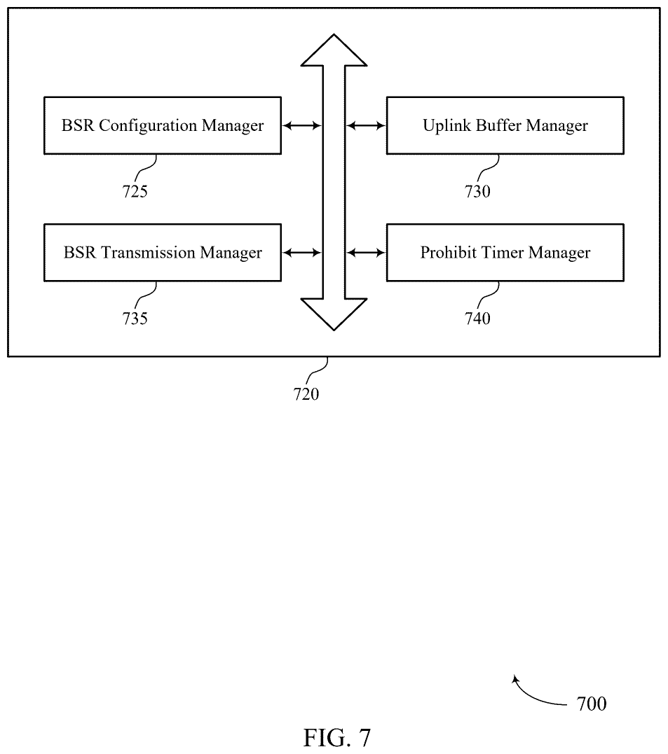

FIG. 7 shows a block diagram 700 of a communications manager 720 that supports unified buffer and delay status reporting in accordance with one or more aspects of the present disclosure. The communications manager 720 may be an example of aspects of a communications manager 520, a communications manager 620, or both, as described herein. The communications manager 720, or various components thereof, may be an example of means for performing various aspects of unified buffer and delay status reporting as described herein. For example, the communications manager 720 may include an BSR configuration manager 725, an uplink buffer manager 730, an BSR transmission manager 735, a prohibit timer manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The BSR configuration manager 725 is capable of, configured to, or operable to support a means for receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The uplink buffer manager 730 is capable of, configured to, or operable to support a means for obtaining, at a first data arrival time, first data to be transmitted in one or more uplink transmissions. The BSR transmission manager 735 is capable of, configured to, or operable to support a means for initiating a unified delay and buffer status report to notify a network entity of a quantity of data that is buffered at the UE for uplink transmission based on one or more of the first time threshold or the second time threshold and an elapsed time from the first data arrival time.

In some examples, the data is associated with a first logical channel of one or more logical channels configured at the UE, and separate buffer status report configurations are provided for each logical channel of the one or more logical channels. In some examples, the unified delay and buffer status report indicates the quantity of data that is buffered at the UE for uplink transmission and a delay status associated with the data.

In some examples, to support receiving the buffer status report configuration, the BSR configuration manager 725 is capable of, configured to, or operable to support a means for receiving the first time threshold associated with the first duration between obtaining the data and transmission of the data. In some examples, to support receiving the buffer status report configuration, the BSR configuration manager 725 is capable of, configured to, or operable to support a means for receiving the second time threshold associated with the second duration between obtaining the data and transmission of the data.

In some examples, the uplink buffer manager 730 is capable of, configured to, or operable to support a means for determining that at least a first portion of the data that is buffered at the UE for uplink transmission has been in an uplink buffer at the UE for at least the first duration. In some examples, the BSR transmission manager 735 is capable of, configured to, or operable to support a means for initiating a first unified delay and buffer status report to notify the network entity that at least the first portion of the data has been in the uplink buffer at the UE for at least the first duration. In some examples, the uplink buffer manager 730 is capable of, configured to, or operable to support a means for determining, subsequent to initiating the first unified delay and buffer status report, that at least a second portion of the data that is buffered at the UE for uplink transmission has been in the uplink buffer at the UE for at least the second duration. In some examples, the BSR transmission manager 735 is capable of, configured to, or operable to support a means for initiating a second unified delay and buffer status report to notify the network entity that at least the second portion of the data has been in the uplink buffer at the UE for at least the second duration.

In some examples, the first time threshold is configured to trigger initiation of the unified delay and buffer status report when new data is obtained for a first logical channel associated with the buffer status report configuration. In some examples, the second time threshold is configured to trigger a second unified delay and buffer status report when at least a portion of the data associated with the first logical channel is present for a duration of time indicated by the second time threshold. In some examples, one or more of the first time threshold or the second time threshold is associated with a prohibit timer that is initiated upon transmission of an associated unified delay and buffer status report, and where a subsequent unified delay and buffer status report for an associated time threshold is not transmitted prior to an expiration of the prohibit timer.

In some examples, to support initiating the unified delay and buffer status report, the uplink buffer manager 730 is capable of, configured to, or operable to support a means for determining that at least a portion of the data that is buffered at the UE for uplink transmission has been in an uplink buffer of a logical channel at the UE for at least the first duration. In some examples, to support initiating the unified delay and buffer status report, the BSR transmission manager 735 is capable of, configured to, or operable to support a means for determining that a pending unified delay and buffer status report associated with the logical channel is not present. In some examples, to support initiating the unified delay and buffer status report, the prohibit timer manager 740 is capable of, configured to, or operable to support a means for determining that a prohibit timer associated with the first duration is not running. In some examples, to support initiating the unified delay and buffer status report, the BSR transmission manager 735 is capable of, configured to, or operable to support a means for generating the unified delay and buffer status report for transmission to the network entity.

In some examples, the BSR transmission manager 735 is capable of, configured to, or operable to support a means for canceling the unified delay and buffer status report if a different unified delay and buffer status report has indicated the quantity of data that is buffered at the UE, if the data that is buffered at the UE has been transmitted, or if the data that is buffered at the UE has been discarded. In some examples, the quantity of data that is buffered at the UE for uplink transmission includes one or more service data units (SDUs) that have been buffered for at least the first duration associated with the first time threshold.

In some examples, to support initiating the unified delay and buffer status report, the BSR transmission manager 735 is capable of, configured to, or operable to support a means for determining that a quantity of unified delay and buffer status reports that have been triggered in a first time period do not exceed a threshold quantity of unified delay and buffer status reports. In some examples, the buffer status report configuration indicates two or more reporting thresholds associated with different time parameters for data that is buffered at the UE to be reported in the unified delay and buffer status report, and where a quantity of reporting thresholds is independent of a quantity of time thresholds. In some examples, the quantity of data associated with each reporting threshold that is buffered at the UE is indicated in the unified delay and buffer status report, including a first quantity of data having a remaining time in an associated packet delay budget that is less than a first reporting threshold, and where the unified delay and buffer status report further indicates a shortest remaining time among the first quantity of data that is less than the first reporting threshold. In some examples, the first quantity of data and the shortest remaining time are provided for each of the two or more reporting thresholds that are not higher than an associated time threshold for triggering the unified delay and buffer status report.

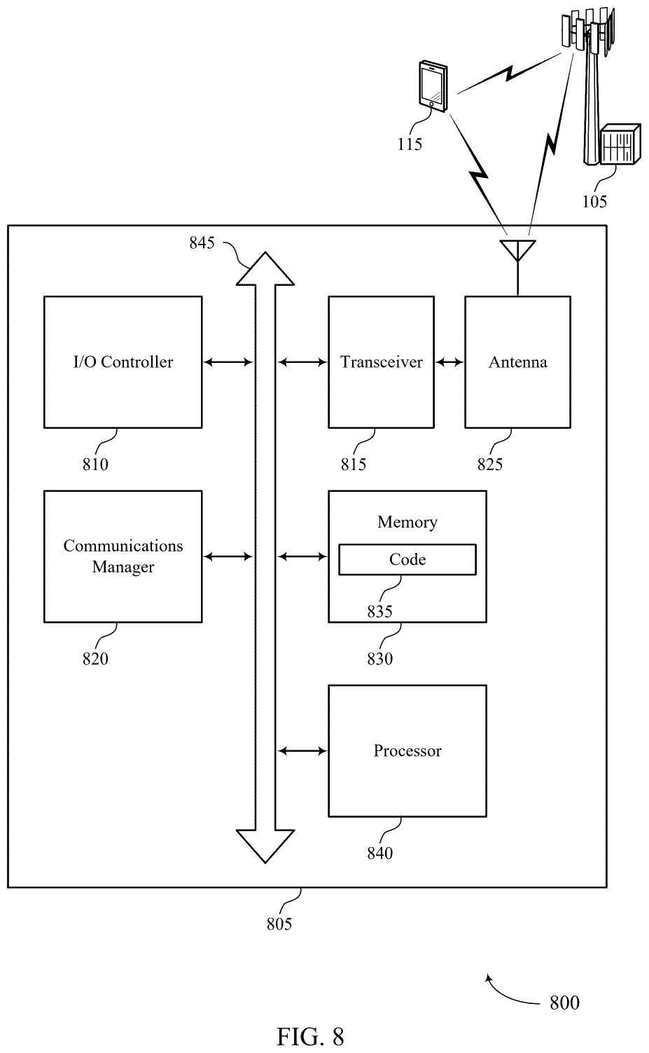

FIG. 8 shows a diagram of a system 800 including a device 805 that supports unified buffer and delay status reporting in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting unified buffer and delay status reporting). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The communications manager 820 is capable of, configured to, or operable to support a means for obtaining, at a first data arrival time, first data to be transmitted in one or more uplink transmissions. The communications manager 820 is capable of, configured to, or operable to support a means for initiating a unified delay and buffer status report to notify a network entity of a quantity of data that is buffered at the UE for uplink transmission based on one or more of the first time threshold or the second time threshold and an elapsed time from the first data arrival time.

By including or configuring the communications manager 820 in accordance with examples as described herein, the device 805 may support techniques for a unified BSR report that provides an indication of both a quantity of data at an uplink buffer at a UE, and an indication of data in the buffer that is approaching a time threshold that indicates the data is stale or no longer useful. Such a unified report may allow for efficient reporting of buffer status and delay information to a network entity, reduced processing, reduced power consumption through transmission of fewer reports, enhanced network reliability, and reduced overhead.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of unified buffer and delay status reporting as described herein, or the at least one processor 840 and the at least one memory 830 may be otherwise configured to, individually or collectively, perform or support such operations.

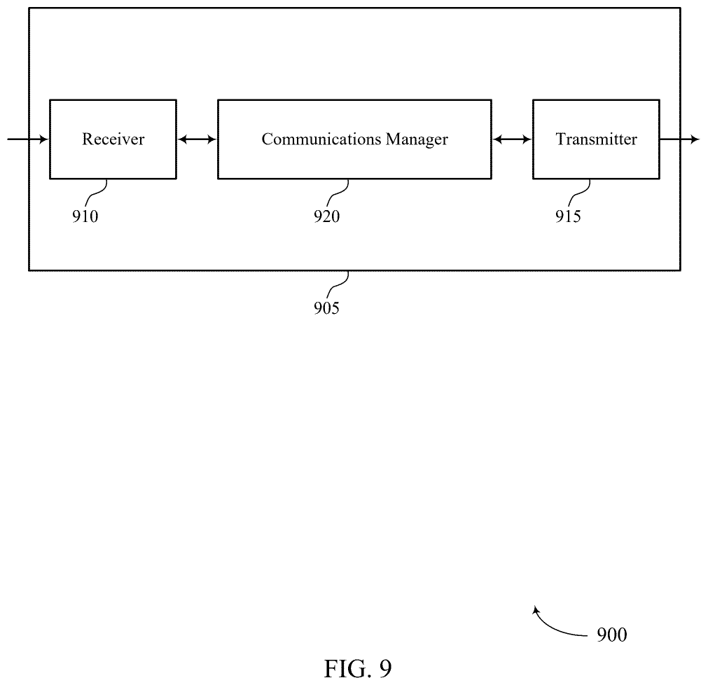

FIG. 9 shows a block diagram 900 of a device 905 that supports unified buffer and delay status reporting in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques.

Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of unified buffer and delay status reporting as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The communications manager 920 is capable of, configured to, or operable to support a means for receiving, from the UE, a unified delay and buffer status report that indicates a quantity of data that is buffered at the UE for uplink transmission and that is to be transmitted within the first time threshold or the second time threshold. The communications manager 920 is capable of, configured to, or operable to support a means for scheduling uplink resources for uplink transmissions of the UE basing at least in part on the unified delay and buffer status report.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for a unified BSR report that provides an indication of both a quantity of data at an uplink buffer at a UE, and an indication of data in the buffer that is approaching a time threshold that indicates the data is stale or no longer useful. Such a unified report may allow for efficient reporting of buffer status and delay information to a network entity, reduced processing, reduced power consumption through transmission of fewer reports, and reduced overhead.

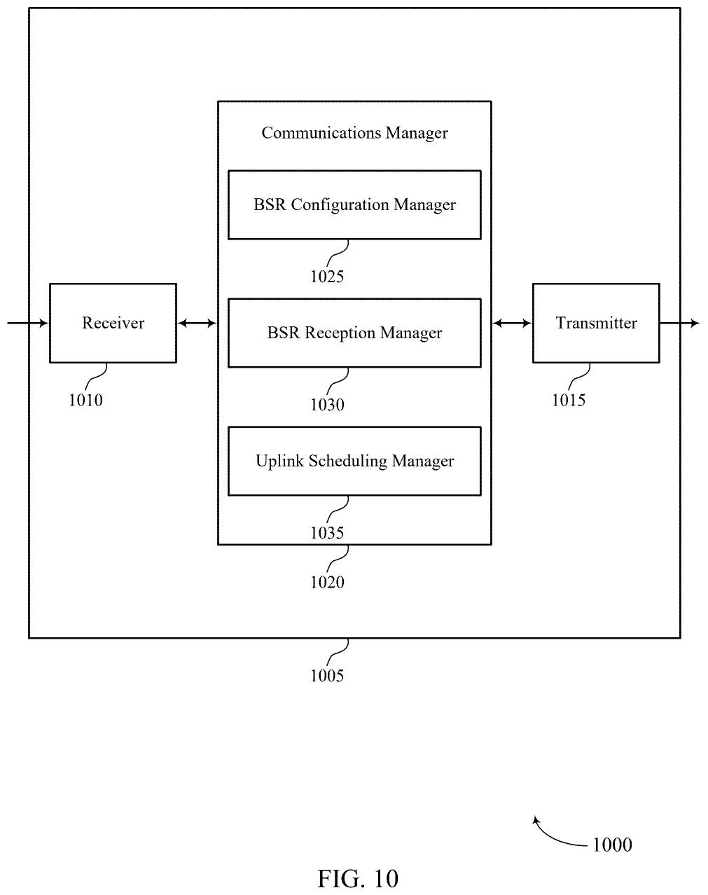

FIG. 10 shows a block diagram 1000 of a device 1005 that supports unified buffer and delay status reporting in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of unified buffer and delay status reporting as described herein. For example, the communications manager 1020 may include an BSR configuration manager 1025, an BSR reception manager 1030, an uplink scheduling manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The BSR configuration manager 1025 is capable of, configured to, or operable to support a means for transmitting, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The BSR reception manager 1030 is capable of, configured to, or operable to support a means for receiving, from the UE, a unified delay and buffer status report that indicates a quantity of data that is buffered at the UE for uplink transmission and that is to be transmitted within the first time threshold or the second time threshold. The uplink scheduling manager 1035 is capable of, configured to, or operable to support a means for scheduling uplink resources for uplink transmissions of the UE based on the unified delay and buffer status report.

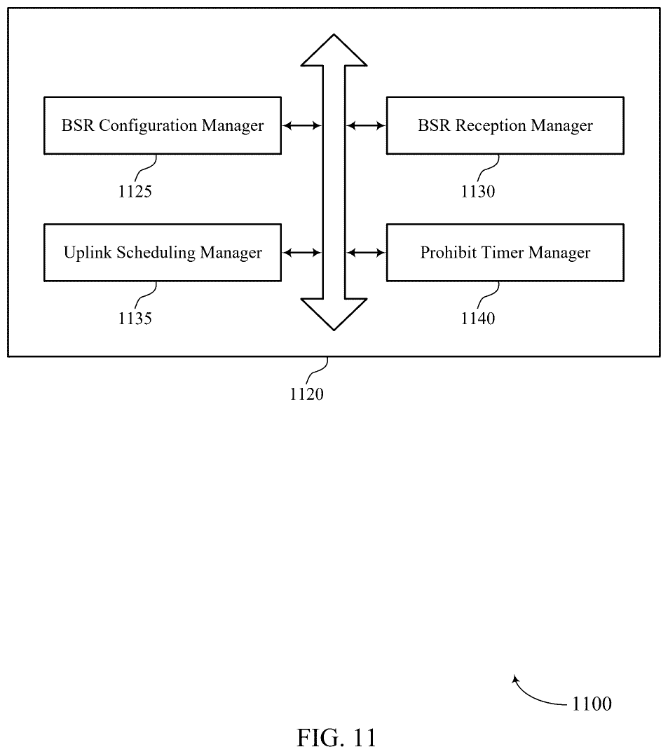

FIG. 11 shows a block diagram 1100 of a communications manager 1120 that supports unified buffer and delay status reporting in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of unified buffer and delay status reporting as described herein. For example, the communications manager 1120 may include an BSR configuration manager 1125, an BSR reception manager 1130, an uplink scheduling manager 1135, a prohibit timer manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The BSR configuration manager 1125 is capable of, configured to, or operable to support a means for transmitting, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The BSR reception manager 1130 is capable of, configured to, or operable to support a means for receiving, from the UE, a unified delay and buffer status report that indicates a quantity of data that is buffered at the UE for uplink transmission and that is to be transmitted within the first time threshold or the second time threshold. The uplink scheduling manager 1135 is capable of, configured to, or operable to support a means for scheduling uplink resources for uplink transmissions of the UE based on the unified delay and buffer status report.

In some examples, the buffer status report configuration is associated with a first logical channel of one or more logical channels configured at the UE, and separate buffer status report configurations are provided for each logical channel of the one or more logical channels. In some examples, the unified delay and buffer status report indicates the quantity of data that is buffered at the UE for uplink transmission and a delay status associated with the data.

In some examples, to support transmitting the buffer status report configuration, the BSR configuration manager 1125 is capable of, configured to, or operable to support a means for transmitting the first time threshold associated with the first duration between obtaining the data and transmission of the data. In some examples, to support transmitting the buffer status report configuration, the BSR configuration manager 1125 is capable of, configured to, or operable to support a means for transmitting the second time threshold associated with the second duration between obtaining the data and transmission of the data.

In some examples, the unified delay and buffer status report is a first unified delay and buffer status report that indicates that at least a first portion of the data has been in an uplink buffer at the UE for at least the first duration, and the BSR reception manager 1130 is capable of, configured to, or operable to support a means for receiving a second unified delay and buffer status report that indicates that at least a second portion of the data has been in the uplink buffer at the UE for at least the second duration.

In some examples, the first time threshold is configured to trigger initiation of the first unified delay and buffer status report when new data is obtained for a first logical channel associated with the buffer status report configuration. In some examples, the second time threshold is configured to trigger the second unified delay and buffer status report when at least a portion of the data associated with the first logical channel is present for a duration of time indicated by the second time threshold. In some examples, one or more of the first time threshold or the second time threshold is associated with a prohibit timer that is initiated upon transmission of an associated unified delay and buffer status report, and where a subsequent unified delay and buffer status report for an associated time threshold is not transmitted prior to an expiration of the prohibit timer.

In some examples, the buffer status report configuration further indicates a prohibit timer duration associated with the first time threshold, and where a second unified delay and buffer status report associated with the first time threshold is not to be transmitted within the prohibit timer duration from the unified delay and buffer status report. In some examples, the buffer status report configuration further indicates to cancel the unified delay and buffer status report if a different unified delay and buffer status report has indicated the quantity of data that is buffered at the UE, if the data that is buffered at the UE has been transmitted, or if the data that is buffered at the UE has been discarded. In some examples, the quantity of data that is buffered at the UE for uplink transmission includes one or more service data units (SDUs) that have been buffered for at least the first duration associated with the first time threshold.

In some examples, the buffer status report configuration further indicates a threshold quantity of unified delay and buffer status reports that can be triggered during a first time period.

In some examples, the buffer status report configuration indicates two or more reporting thresholds associated with different time parameters for data that is buffered at the UE to be reported in the unified delay and buffer status report, and where a quantity of reporting thresholds is independent of a quantity of time thresholds. In some examples, the quantity of data associated with each reporting threshold that is buffered at the UE is indicated in the unified delay and buffer status report, including a first quantity of data having a remaining time in an associated packet delay budget that is less than a first reporting threshold, and where the unified delay and buffer status report further indicates a shortest remaining time among the first quantity of data that is less than the first reporting threshold. In some examples, the first quantity of data and the shortest remaining time are provided for each of the two or more reporting thresholds that are not higher than an associated time threshold for triggering the unified delay and buffer status report.

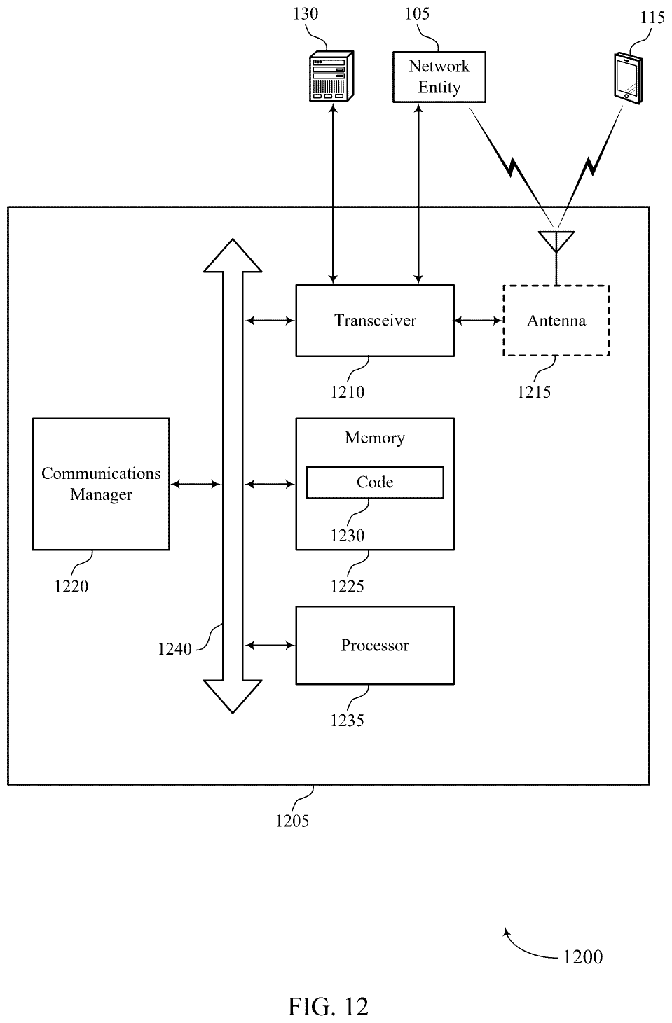

FIG. 12 shows a diagram of a system 1200 including a device 1205 that supports unified buffer and delay status reporting in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting unified buffer and delay status reporting). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The communications manager 1220 is capable of, configured to, or operable to support a means for receiving, from the UE, a unified delay and buffer status report that indicates a quantity of data that is buffered at the UE for uplink transmission and that is to be transmitted within the first time threshold or the second time threshold. The communications manager 1220 is capable of, configured to, or operable to support a means for scheduling uplink resources for uplink transmissions of the UE basing at least in part on the unified delay and buffer status report.

By including or configuring the communications manager 1220 in accordance with examples as described herein, the device 1205 may support techniques for a unified BSR report that provides an indication of both a quantity of data at an uplink buffer at a UE, and an indication of data in the buffer that is approaching a time threshold that indicates the data is stale or no longer useful. Such a unified report may allow for efficient reporting of buffer status and delay information to a network entity, reduced processing, reduced power consumption through transmission of fewer reports, enhanced network reliability, and reduced overhead.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of unified buffer and delay status reporting as described herein, or the at least one processor 1235 and the at least one memory 1225 may be otherwise configured to, individually or collectively, perform or support such operations.

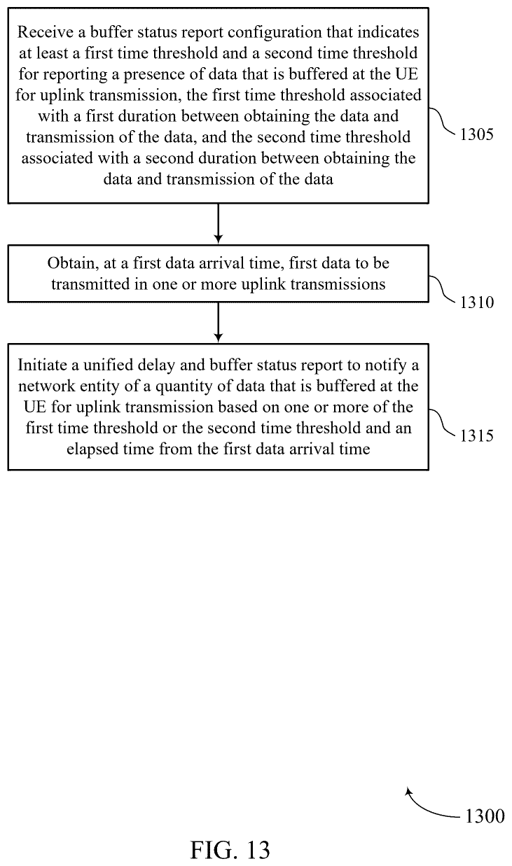

FIG. 13 shows a flowchart illustrating a method 1300 that supports unified buffer and delay status reporting in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The operations of 1305 may be performed in accordance with examples as disclosed herein. In some examples, aspects of the operations of 1305 may be performed by an BSR configuration manager 725 as described with reference to FIG. 7.

At 1310, the method may include obtaining, at a first data arrival time, first data to be transmitted in one or more uplink transmissions. The operations of 1310 may be performed in accordance with examples as disclosed herein. In some examples, aspects of the operations of 1310 may be performed by an uplink buffer manager 730 as described with reference to FIG. 7.

At 1315, the method may include initiating a unified delay and buffer status report to notify a network entity of a quantity of data that is buffered at the UE for uplink transmission based on one or more of the first time threshold or the second time threshold and an elapsed time from the first data arrival time. The operations of 1315 may be performed in accordance with examples as disclosed herein. In some examples, aspects of the operations of 1315 may be performed by an BSR transmission manager 735 as described with reference to FIG. 7.

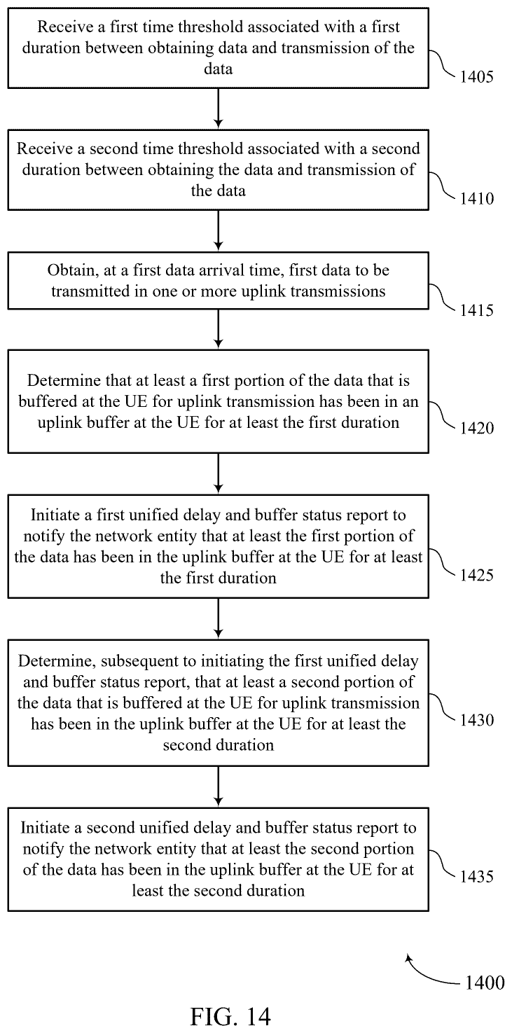

FIG. 14 shows a flowchart illustrating a method 1400 that supports unified buffer and delay status reporting in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving A first time threshold associated with A first duration between obtaining data and transmission of the data. The operations of 1405 may be performed in accordance with examples as disclosed herein. In some examples, aspects of the operations of 1405 may be performed by an BSR configuration manager 725 as described with reference to FIG. 7.

At 1410, the method may include receiving A second time threshold associated with A second duration between obtaining the data and transmission of the data. The operations of 1410 may be performed in accordance with examples as disclosed herein. In some examples, aspects of the operations of 1410 may be performed by an BSR configuration manager 725 as described with reference to FIG. 7.

At 1415, the method may include obtaining, at a first data arrival time, first data to be transmitted in one or more uplink transmissions. The operations of 1415 may be performed in accordance with examples as disclosed herein. In some examples, aspects of the operations of 1415 may be performed by an uplink buffer manager 730 as described with reference to FIG. 7.

At 1420, the method may include determining that at least a first portion of the data that is buffered at the UE for uplink transmission has been in an uplink buffer at the UE for at least the first duration. The operations of 1420 may be performed in accordance with examples as disclosed herein. In some examples, aspects of the operations of 1420 may be performed by an uplink buffer manager 730 as described with reference to FIG. 7.

At 1425, the method may include initiating a first unified delay and buffer status report to notify the network entity that at least the first portion of the data has been in the uplink buffer at the UE for at least the first duration. The operations of 1425 may be performed in accordance with examples as disclosed herein. In some examples, aspects of the operations of 1425 may be performed by an BSR transmission manager 735 as described with reference to FIG. 7.

At 1430, the method may include determining, subsequent to initiating the first unified delay and buffer status report, that at least a second portion of the data that is buffered at the UE for uplink transmission has been in the uplink buffer at the UE for at least the second duration. The operations of 1430 may be performed in accordance with examples as disclosed herein. In some examples, aspects of the operations of 1430 may be performed by an uplink buffer manager 730 as described with reference to FIG. 7.

At 1435, the method may include initiating a second unified delay and buffer status report to notify the network entity that at least the second portion of the data has been in the uplink buffer at the UE for at least the second duration. The operations of 1435 may be performed in accordance with examples as disclosed herein. In some examples, aspects of the operations of 1435 may be performed by an BSR transmission manager 735 as described with reference to FIG. 7.

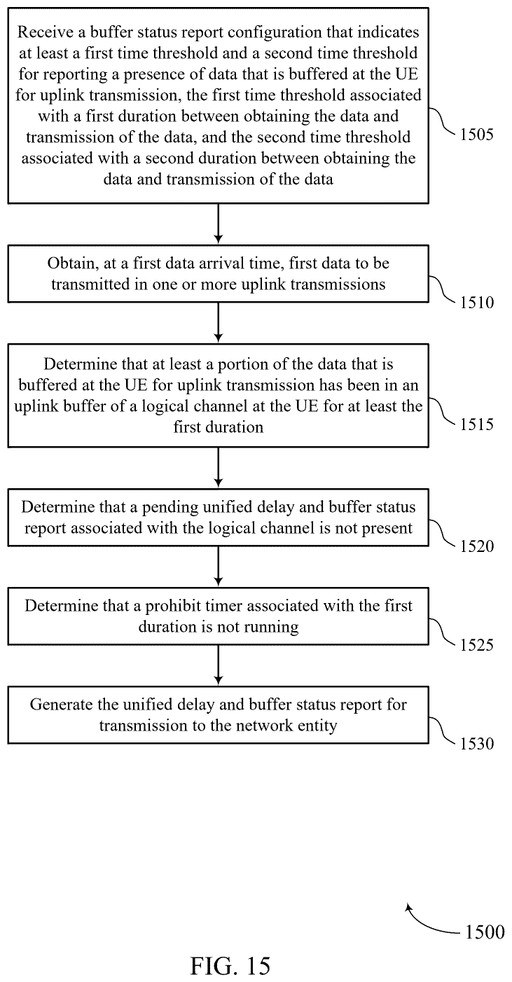

FIG. 15 shows a flowchart illustrating a method 1500 that supports unified buffer and delay status reporting in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The operations of 1505 may be performed in accordance with examples as disclosed herein. In some examples, aspects of the operations of 1505 may be performed by an BSR configuration manager 725 as described with reference to FIG. 7.

At 1510, the method may include obtaining, at a first data arrival time, first data to be transmitted in one or more uplink transmissions. The operations of 1510 may be performed in accordance with examples as disclosed herein. In some examples, aspects of the operations of 1510 may be performed by an uplink buffer manager 730 as described with reference to FIG. 7.

At 1515, the method may include determining that at least a portion of the data that is buffered at the UE for uplink transmission has been in an uplink buffer of a logical channel at the UE for at least the first duration. The operations of 1515 may be performed in accordance with examples as disclosed herein. In some examples, aspects of the operations of 1515 may be performed by an uplink buffer manager 730 as described with reference to FIG. 7.

At 1520, the method may include determining that a pending unified delay and buffer status report associated with the logical channel is not present. The operations of 1520 may be performed in accordance with examples as disclosed herein. In some examples, aspects of the operations of 1520 may be performed by an BSR transmission manager 735 as described with reference to FIG. 7.

At 1525, the method may include determining that a prohibit timer associated with the first duration is not running. The operations of 1525 may be performed in accordance with examples as disclosed herein. In some examples, aspects of the operations of 1525 may be performed by a prohibit timer manager 740 as described with reference to FIG. 7.

At 1530, the method may include generating the unified delay and buffer status report for transmission to the network entity. The operations of 1530 may be performed in accordance with examples as disclosed herein. In some examples, aspects of the operations of 1530 may be performed by an BSR transmission manager 735 as described with reference to FIG. 7.

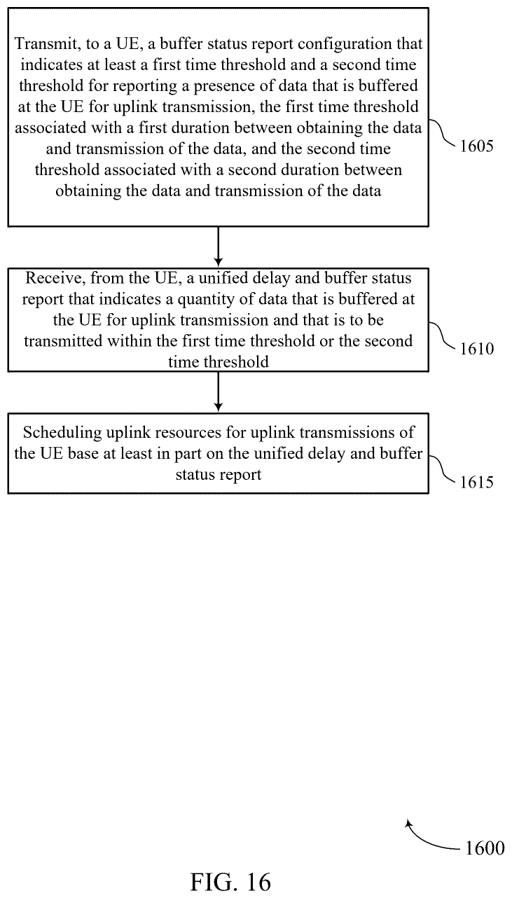

FIG. 16 shows a flowchart illustrating a method 1600 that supports unified buffer and delay status reporting in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data. The operations of 1605 may be performed in accordance with examples as disclosed herein. In some examples, aspects of the operations of 1605 may be performed by an BSR configuration manager 1125 as described with reference to FIG. 11.

At 1610, the method may include receiving, from the UE, a unified delay and buffer status report that indicates a quantity of data that is buffered at the UE for uplink transmission and that is to be transmitted within the first time threshold or the second time threshold. The operations of 1610 may be performed in accordance with examples as disclosed herein. In some examples, aspects of the operations of 1610 may be performed by an BSR reception manager 1130 as described with reference to FIG. 11.

At 1615, the method may include scheduling uplink resources for uplink transmissions of the UE based on the unified delay and buffer status report. The operations of 1615 may be performed in accordance with examples as disclosed herein. In some examples, aspects of the operations of 1615 may be performed by an uplink scheduling manager 1135 as described with reference to FIG. 11.

The following provides an overview of aspects of the present disclosure:

Aspect 1: A method for wireless communications at a UE, comprising: receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data; obtaining, at a first data arrival time, first data to be transmitted in one or more uplink transmissions; and initiating a unified delay and buffer status report to notify a network entity of a quantity of data that is buffered at the UE for uplink transmission based at least in part on one or more of the first time threshold or the second time threshold and an elapsed time from the first data arrival time.

Aspect 2: The method of aspect 1, wherein the data is associated with a first logical channel of one or more logical channels configured at the UE, and separate buffer status report configurations are provided for each logical channel of the one or more logical channels.

Aspect 3: The method of any of aspects 1 through 2, wherein the unified delay and buffer status report indicates the quantity of data that is buffered at the UE for uplink transmission and a delay status associated with the data.

Aspect 4: The method of any of aspects 1 through 3, wherein receiving the buffer status report configuration further comprises: receiving the first time threshold associated with the first duration between obtaining the data and transmission of the data; and receiving the second time threshold associated with the second duration between obtaining the data and transmission of the data.

Aspect 5: The method of aspect 4, further comprising: determining that at least a first portion of the data that is buffered at the UE for uplink transmission has been in an uplink buffer at the UE for at least the first duration; initiating a first unified delay and buffer status report to notify the network entity that at least the first portion of the data has been in the uplink buffer at the UE for at least the first duration; determining, subsequent to initiating the first unified delay and buffer status report, that at least a second portion of the data that is buffered at the UE for uplink transmission has been in the uplink buffer at the UE for at least the second duration; and initiating a second unified delay and buffer status report to notify the network entity that at least the second portion of the data has been in the uplink buffer at the UE for at least the second duration.

Aspect 6: The method of any of aspects 4 through 5, wherein the first time threshold is configured to trigger initiation of the unified delay and buffer status report when new data is obtained for a first logical channel associated with the buffer status report configuration.

Aspect 7: The method of aspect 6, wherein the second time threshold is configured to trigger a second unified delay and buffer status report when at least a portion of the data associated with the first logical channel is present for a duration of time indicated by the second time threshold.

Aspect 8: The method of any of aspects 4 through 7, wherein one or more of the first time threshold or the second time threshold is associated with a prohibit timer that is initiated upon transmission of an associated unified delay and buffer status report, and a subsequent unified delay and buffer status report for an associated time threshold is not transmitted prior to an expiration of the prohibit timer.

Aspect 9: The method of any of aspects 1 through 8, wherein initiating the unified delay and buffer status report comprises: determining that at least a portion of the data that is buffered at the UE for uplink transmission has been in an uplink buffer of a logical channel at the UE for at least the first duration; determining that a pending unified delay and buffer status report associated with the logical channel is not present; determining that a prohibit timer associated with the first duration is not running; and generating the unified delay and buffer status report for transmission to the network entity.

Aspect 10: The method of any of aspects 1 through 9, further comprising: canceling the unified delay and buffer status report if a different unified delay and buffer status report has indicated the quantity of data that is buffered at the UE, if the data that is buffered at the UE has been transmitted, or if the data that is buffered at the UE has been discarded.

Aspect 11: The method of any of aspects 1 through 10, wherein the quantity of data that is buffered at the UE for uplink transmission includes one or more service data units (SDUs) that have been buffered for at least the first duration associated with the first time threshold.

Aspect 12: The method of any of aspects 1 through 11, wherein initiating the unified delay and buffer status report comprises: determining that a quantity of unified delay and buffer status reports that have been triggered in a first time period do not exceed a threshold quantity of unified delay and buffer status reports.

Aspect 13: The method of any of aspects 1 through 12, wherein the buffer status report configuration indicates two or more reporting thresholds associated with different time parameters for data that is buffered at the UE to be reported in the unified delay and buffer status report, and a quantity of reporting thresholds is independent of a quantity of time thresholds.

Aspect 14: The method of aspect 13, wherein the quantity of data associated with each reporting threshold that is buffered at the UE is indicated in the unified delay and buffer status report, including a first quantity of data having a remaining time in an associated packet delay budget that is less than a first reporting threshold, and the unified delay and buffer status report further indicates a shortest remaining time among the first quantity of data that is less than the first reporting threshold.

Aspect 15: The method of aspect 14, wherein the first quantity of data and the shortest remaining time are provided for each of the two or more reporting thresholds that are not higher than an associated time threshold for triggering the unified delay and buffer status report.

Aspect 16: A method for wireless communications at a network entity, comprising: transmitting, to a UE, a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data; receiving, from the UE, a unified delay and buffer status report that indicates a quantity of data that is buffered at the UE for uplink transmission and that is to be transmitted within the first time threshold or the second time threshold; and scheduling uplink resources for uplink transmissions of the UE based at least in part on the unified delay and buffer status report.

Aspect 17: The method of aspect 16, wherein the buffer status report configuration is associated with a first logical channel of one or more logical channels configured at the UE, and separate buffer status report configurations are provided for each logical channel of the one or more logical channels.

Aspect 18: The method of any of aspects 16 through 17, wherein the unified delay and buffer status report indicates the quantity of data that is buffered at the UE for uplink transmission and a delay status associated with the data.

Aspect 19: The method of any of aspects 16 through 18, wherein transmitting the buffer status report configuration further comprises: transmitting the first time threshold associated with the first duration between obtaining the data and transmission of the data; and transmitting the second time threshold associated with the second duration between obtaining the data and transmission of the data.

Aspect 20: The method of aspect 19, wherein the unified delay and buffer status report is a first unified delay and buffer status report that indicates that at least a first portion of the data has been in an uplink buffer at the UE for at least the first duration, and wherein the method further comprises: receiving a second unified delay and buffer status report that indicates that at least a second portion of the data has been in the uplink buffer at the UE for at least the second duration.

Aspect 21: The method of aspect 20, wherein the first time threshold is configured to trigger initiation of the first unified delay and buffer status report when new data is obtained for a first logical channel associated with the buffer status report configuration.

Aspect 22: The method of aspect 21, wherein the second time threshold is configured to trigger the second unified delay and buffer status report when at least a portion of the data associated with the first logical channel is present for a duration of time indicated by the second time threshold.

Aspect 23: The method of any of aspects 19 through 22, wherein one or more of the first time threshold or the second time threshold is associated with a prohibit timer that is initiated upon transmission of an associated unified delay and buffer status report, and a subsequent unified delay and buffer status report for an associated time threshold is not transmitted prior to an expiration of the prohibit timer.

Aspect 24: The method of any of aspects 16 through 23, wherein the buffer status report configuration further indicates a prohibit timer duration associated with the first time threshold, and a second unified delay and buffer status report associated with the first time threshold is not to be transmitted within the prohibit timer duration from the unified delay and buffer status report.

Aspect 25: The method of any of aspects 16 through 24, wherein the buffer status report configuration further indicates to cancel the unified delay and buffer status report if a different unified delay and buffer status report has indicated the quantity of data that is buffered at the UE, if the data that is buffered at the UE has been transmitted, or if the data that is buffered at the UE has been discarded.

Aspect 26: The method of any of aspects 16 through 25, wherein the quantity of data that is buffered at the UE for uplink transmission includes one or more service data units (SDUs) that have been buffered for at least the first duration associated with the first time threshold.

Aspect 27: The method of any of aspects 16 through 26, wherein the buffer status report configuration further indicates a threshold quantity of unified delay and buffer status reports that can be triggered during a first time period.

Aspect 28: The method of any of aspects 16 through 27, wherein the buffer status report configuration indicates two or more reporting thresholds associated with different time parameters for data that is buffered at the UE to be reported in the unified delay and buffer status report, and a quantity of reporting thresholds is independent of a quantity of time thresholds.

Aspect 29: The method of aspect 28, wherein the quantity of data associated with each reporting threshold that is buffered at the UE is indicated in the unified delay and buffer status report, including a first quantity of data having a remaining time in an associated packet delay budget that is less than a first reporting threshold, and the unified delay and buffer status report further indicates a shortest remaining time among the first quantity of data that is less than the first reporting threshold.

Aspect 30: The method of aspect 29, wherein the first quantity of data and the shortest remaining time are provided for each of the two or more reporting thresholds that are not higher than an associated time threshold for triggering the unified delay and buffer status report.

Aspect 31: A UE for wireless communications, comprising one or more memories storing processor-executable code, and one or more processors coupled with the one or more memories and individually or collectively operable to execute the code to cause the UE to perform a method of any of aspects 1 through 15.

Aspect 32: A UE for wireless communications, comprising at least one means for performing a method of any of aspects 1 through 15.

Aspect 33: A non-transitory computer-readable medium storing code for wireless communications, the code comprising instructions executable by one or more processors to perform a method of any of aspects 1 through 15.

Aspect 34: A network entity for wireless communications, comprising one or more memories storing processor-executable code, and one or more processors coupled with the one or more memories and individually or collectively operable to execute the code to cause the network entity to perform a method of any of aspects 16 through 30.

Aspect 35: A network entity for wireless communications, comprising at least one means for performing a method of any of aspects 16 through 30.

Aspect 36: A non-transitory computer-readable medium storing code for wireless communications, the code comprising instructions executable by one or more processors to perform a method of any of aspects 16 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data;
obtain, at a first data arrival time, first data to be transmitted in one or more uplink transmissions; and
initiate a unified delay and buffer status report to notify a network entity of a quantity of data that is buffered at the UE for uplink transmission based at least in part on one or more of the first time threshold or the second time threshold and an elapsed time from the first data arrival time.

2. The UE of claim 1, wherein the data is associated with a first logical channel of one or more logical channels configured at the UE, and separate buffer status report configurations are provided for each logical channel of the one or more logical channels.

3. The UE of claim 1, wherein the unified delay and buffer status report indicates the quantity of data that is buffered at the UE for uplink transmission and a delay status associated with the data.

4. The UE of claim 1, wherein, to receive the buffer status report configuration, the one or more processors are individually or collectively further operable to execute the code to cause the UE to:
receive the first time threshold associated with the first duration between obtaining the data and transmission of the data; and
receive the second time threshold associated with the second duration between obtaining the data and transmission of the data.

5. The UE of claim 4, wherein the one or more processors are individually or collectively further operable to execute the code to cause the UE to:
determine that at least a first portion of the data that is buffered at the UE for uplink transmission has been in an uplink buffer at the UE for at least the first duration;
initiate a first unified delay and buffer status report to notify the network entity that at least the first portion of the data has been in the uplink buffer at the UE for at least the first duration;
determine, subsequent to initiating the first unified delay and buffer status report, that at least a second portion of the data that is buffered at the UE for uplink transmission has been in the uplink buffer at the UE for at least the second duration; and
initiate a second unified delay and buffer status report to notify the network entity that at least the second portion of the data has been in the uplink buffer at the UE for at least the second duration.

6. The UE of claim 4, wherein the first time threshold is configured to trigger initiation of the unified delay and buffer status report when new data is obtained for a first logical channel associated with the buffer status report configuration.

7. The UE of claim 6, wherein the second time threshold is configured to trigger a second unified delay and buffer status report when at least a portion of the data associated with the first logical channel is present for a duration of time indicated by the second time threshold.

8. The UE of claim 4, wherein one or more of the first time threshold or the second time threshold is associated with a prohibit timer that is initiated upon transmission of an associated unified delay and buffer status report, and wherein a subsequent unified delay and buffer status report for an associated time threshold is not transmitted prior to an expiration of the prohibit timer.

9. The UE of claim 1, wherein, to initiate the unified delay and buffer status report, the one or more processors are individually or collectively operable to execute the code to cause the UE to:
determine that at least a portion of the data that is buffered at the UE for uplink transmission has been in an uplink buffer of a logical channel at the UE for at least the first duration;
determine that a pending unified delay and buffer status report associated with the logical channel is not present;
determine that a prohibit timer associated with the first duration is not running; and
generate the unified delay and buffer status report for transmission to the network entity.

10. The UE of claim 1, wherein the one or more processors are individually or collectively further operable to execute the code to cause the UE to:
cancel the unified delay and buffer status report if a different unified delay and buffer status report has indicated the quantity of data that is buffered at the UE, if the data that is buffered at the UE has been transmitted, or if the data that is buffered at the UE has been discarded.

11. The UE of claim 1, wherein the quantity of data that is buffered at the UE for uplink transmission includes one or more service data units (SDUs) that have been buffered for at least the first duration associated with the first time threshold.

12. The UE of claim 1, wherein, to initiate the unified delay and buffer status report, the one or more processors are individually or collectively operable to execute the code to cause the UE to:
determine that a quantity of unified delay and buffer status reports that have been triggered in a first time period do not exceed a threshold quantity of unified delay and buffer status reports.

13. The UE of claim 1, wherein the buffer status report configuration indicates two or more reporting thresholds associated with different time parameters for data that is buffered at the UE to be reported in the unified delay and buffer status report, and wherein a quantity of reporting thresholds is independent of a quantity of time thresholds.

14. A method for wireless communications at a user equipment (UE), comprising:
receiving a buffer status report configuration that indicates at least a first time threshold and a second time threshold for reporting a presence of data that is buffered at the UE for uplink transmission, the first time threshold associated with a first duration between obtaining the data and transmission of the data, and the second time threshold associated with a second duration between obtaining the data and transmission of the data;
obtaining, at a first data arrival time, first data to be transmitted in one or more uplink transmissions; and
initiating a unified delay and buffer status report to notify a network entity of a quantity of data that is buffered at the UE for uplink transmission based at least in part on one or more of the first time threshold or the second time threshold and an elapsed time from the first data arrival time.

15. The method of claim 14, wherein the data is associated with a first logical channel of one or more logical channels configured at the UE, and separate buffer status report configurations are provided for each logical channel of the one or more logical channels.

16. The method of claim 14, wherein the unified delay and buffer status report indicates the quantity of data that is buffered at the UE for uplink transmission and a delay status associated with the data.

17. The method of claim 14, wherein receiving the buffer status report configuration further comprises:
receiving the first time threshold associated with the first duration between obtaining the data and transmission of the data; and
receiving the second time threshold associated with the second duration between obtaining the data and transmission of the data.

18. The method of claim 14, wherein initiating the unified delay and buffer status report comprises:
determining that at least a portion of the data that is buffered at the UE for uplink transmission has been in an uplink buffer of a logical channel at the UE for at least the first duration;
determining that a pending unified delay and buffer status report associated with the logical channel is not present;
determining that a prohibit timer associated with the first duration is not running; and
generating the unified delay and buffer status report for transmission to the network entity.

19. The method of claim 14, wherein the buffer status report configuration indicates two or more reporting thresholds associated with different time parameters for data that is buffered at the UE to be reported in the unified delay and buffer status report, and wherein a quantity of reporting thresholds is independent of a quantity of time thresholds.

20. A non-transitory computer-readable medium storing code for wireless communications, the code comprising instructions executable by one or more processors to:
receive a buffer status report configuration that indicates at least a first time threshold and a second time threshold for reporting a presence of data that is buffered at a user equipment (UE) for uplink transmission, the first time threshold associated with a first duration between obtaining the data and transmission of the data, and the second time threshold associated with a second duration between obtaining the data and transmission of the data;
obtain, at a first data arrival time, first data to be transmitted in one or more uplink transmissions; and
initiate a unified delay and buffer status report to notify a network entity of a quantity of data that is buffered at the UE for uplink transmission based at least in part on one or more of the first time threshold or the second time threshold and an elapsed time from the first data arrival time.
